(19) United States
(12) Patent Application Publication
(10) Pub. No.: US 2011/0247465 A1
(43) Pub. Date: Oct. 13, 2011

(54) COATED CUTTING INSERT FOR ROUGH TURNING

(75) Inventors: Hanna Lind, Stockholm (SE); Hindrik Engstrom, Soderbarke (SE)

(73) Assignee: SECO TOOLS AB, Fagersta (SE)

(21) Appl. No.: 13/140,660

(22) PCT Filed: Dec. 17, 2009
(86) PCT No.: PCT/SE2009/051447

§ 371 Date: Jun. 17, 2011

(30) Foreign Application Priority Data
Dec. 18, 2008 (SE) 0802599-1

(51) Int. Cl. B23B 27/16; B23B 1/00; B32B 3/00

(52) U.S. Cl. 82/1.11; 428/336; 407/119

(57) ABSTRACT

A cutting tool insert of a cemented carbide substrate and a coating. The cemented carbide substrate includes WC, 8-11 wt-% Co, 6.5-11 wt-% cubic carbides of metals from the groups IVb, Vb and VIb with a binder phase that is highly alloyed with tungsten. The cemented carbide has a coercivity of 8-14 kA/m. The coating includes at least one 2-9 μm thick α-Al₂O₃ layer composed of columnar grains with texture coefficients, TC(006)>2 and <6. Simultaneously, TC(012), TC(110), TC(113), TC(202), TC(024) and TC(116) are all <1 and TC(104) is the second highest texture coefficient. The total coating thickness is between 7 and 15 μm.

### BACKGROUND OF THE INVENTION

The present invention relates to a coated cemented carbide cutting tool insert particularly useful for toughness demanding machining such as medium and rough turning of steels. The invention combines a substrate with a tough surface zone and a coating with at least one layer of (006)-textured α-Al₂O₃.

When cemented carbide cutting tools are used in machining of steels, the tool is worn by different mechanisms such as abrasive and chemical wear and chipping and fracturing of the cutting edge. Thin surface layers of wear resistant carbide, nitride, carbonitride and/or oxide compounds formed by various vapor deposition techniques are common components in modern coatings of cutting tools. Such coatings contribute to increase the abrasive wear resistance, but also act as thermal barriers for diffusion of heat from the cutting surface into the underlying cemented carbide substrate. A high temperature within the edge region in combination with high cutting forces result in an increase of the creep deformation within the affected surface region of the substrate and the cutting edge deforms plastically. It is consequently crucial that inserts intended for machining of steel provide good deformation resistance, wear resistance and high toughness.

The different wear mechanisms stated above appear in different applications of the tool. A cutting tool grade for medium to rough turning must have high enough bulk toughness to withstand large chip-to-tool contact areas, provide high edge line integrity and toughness at small feeds and depths of cut, while having high resistance to creep deformation for long periods of time in cut. These kinds of grades are commonly used for the first skin removing cuts in steel components, often large in size with irregular shapes creating an intermittent cutting mode with varying temperatures at the cutting edge. Hence, the tool grade must excel in toughness as well as in wear resistance.

### OBJECT AND SUMMARY OF THE PRESENT INVENTION

It is an object of the present invention to provide a new, improved α-Al₂O₃ coated grade for medium and rough turning of steels and stainless steels with good deformation resistance, wear resistance and high toughness.

It has been found that a relatively thick nucleated α-Al₂O₃ with a strong, fully controlled (006) growth texture in combination with a substrate of relatively high cobalt content shows enhanced wear resistance in combination with edge strength and toughness in medium and rough turning of steels and turning of stainless steels.

### BRIEF DESCRIPTION OF THE DRAWINGS

FIG. 1 shows a light optical image from a polished cross section of the surface zone of the tool insert according to the invention.

A=alumina layer

B=MTCVD layer

C=binder phase enriched zone

D=bulk substrate

### DETAILED DESCRIPTION OF THE PRESENT INVENTION

The present invention combines either of the following two cemented carbide substrates with the (006)-textured Al₂O₃ coating described below.

### Substrates

According to the present invention a coated cutting tool insert consists of a cemented carbide body with a composition of 8-11 wt-%, Co, 6.5-11 wt-% carbides of Ti, Nb and Ti and balance WC.

The cobalt binder phase is highly alloyed with tungsten. The concentration of W in the binder phase may be expressed as the S-value=σ/16.1, where a is the measured magnetic moment of the binder phase in μTm³ kg⁻¹. The S-value depends on the content of tungsten in the binder phase and increases with a decreasing tungsten content. Thus, for pure cobalt, or a binder that is saturated with carbon, S=1 and for a binder phase that contains W in an amount that corresponds to the borderline to formation of η-phase, S=0.78. S should be slightly above the borderline value of 0.78, preferably 0.79-0.90, most preferably 0.80-0.85.

At least on one side, the cemented carbide insert has a 10-40 μm thick, preferably 20-40 μm thick, most preferably 20-30 μm thick, essentially cubic carbide phase free and binder phase enriched surface zone with an average binder phase content of 1.2-2.5 times the nominal binder phase content.

In a first embodiment the cemented carbide has a composition of 9.0-10.0 wt-% Co, 6.5-10 wt-% cubic carbides of Ti, Nb and Ti, preferably 3.0-4.0 wt-% TaC, 1.7-2.7 wt-% NbC and 2.0-3.0 wt-% TiC, and balance WC. The coercivity is 9-14 kA/m, preferably 10.5-12.5 kA/m.

In a second embodiment the cemented carbide has a composition of 9.5-10.5 wt-% Co, 8.0-11.0 wt % cubic carbides of metals from groups IVb, Vb and VIb of the periodic table, preferably of Ti, Nb and Ti preferably 4.0-5.0 wt-% TaC, 2.4-3.4 wt-% NbC and 2.0-3.0 wt-% TiC, and balance WC. The coercivity is 8-13 kA/m, preferably 9.5-11.5 kA/m.

### Coating

The coating comprises of a MTCVD Ti(C,N) first layer adjacent the substrate having a thickness from 2 to 10 μm, preferably from 5 to 7 μm. It can be substituted by CVD Ti(C,N), CVD TiN, CVD TiC, MTCVD Zr(C,N) or combinations thereof. The first layer is terminated by a bonding layer 0.5-1.01 μm thick of (Ti,Al)(C,O,N). Preferably there is an intermediate layer of TiN between the substrate and said first layer with a thickness of <3 μm, preferably 0.5-2 μm.

On top of the bonding layer an α-Al₂O₃ layer is deposited. The α-Al₂O₃ layer according to the invention consists of nucleated α-Al₂O₃ with columnar grains with a strong (006) texture. The columnar grains have a length/width ratio of from 2 to 12 preferably 4 to 8 μm. The thickness of the alumina layer is from 2 to 9 μm, preferably from 4 to 6 μm. The (006)-textured α-Al₂O₃ layer is the uppermost layer and the surface of α-Al₂O₃ is wet-blasted. Typically, the surface roughness is Ra=0.5-1.0 μm, preferably 0.5-0.7 μm.

The texture coefficients (TC) for the α-Al₂O₃ layer is determined as follows:

$$TC ( hkl ) = {\frac{I ( hkl )}{{I}_{0} ( hkl )} [ \frac{1}{n} {\sum }_{n = 1}^{n} \frac{I ( hkl )}{{I}_{0} ( hkl )} ]}^{- 1}$$

where
I(hkl)=intensity of the (hkl) reflection,
Io(hkl)=standard intensity according to JCPDS card no 46-1212,
n=number of reflections used in the calculation,
(hkl) reflections used are: (012), (104), (110), (006), (113), (202), (024) and (116).
The texture of the alumina layer is as follows:
TC(006)>2, preferably >3 and <6, and preferably <5. Simultaneously, TC(012), TC(110), TC(113), TC(202), TC(024) and TC(116) are all <1 and TC(104) is the second highest texture coefficient.

In a preferred embodiment TC(104)<2 and >0.5. The total coating thickness is between 7 and 15 μm, preferably between 9 and 13 μm.

### Method

Cutting tool inserts according to the description above comprising a cemented carbide substrate consisting of a binder phase of Co, WC and a cubic carbonitride phase with a binder phase enriched surface zone essentially free of cubic phase and a coating are made using the powder metallurgical methods milling, pressing and sintering.

Well controlled amounts of nitrogen are added through the powder e.g. as nitrides. The optimum amount of nitrogen to be added depends on the composition of the cemented carbide and in particular on the amount of cubic phases and is higher than 1.7%, preferably 1.8-5.0%, most preferably 3.0-4.0 wt-%, of the weight of the elements from groups IVb and Vb of the periodic table. The exact conditions depend to a certain extent on the design of the sintering equipment being used. It is within the purview of the skilled artisan to determine and to modify the nitrogen addition and the sintering process in accordance with the present specification in order to obtain the desired result.

The raw materials are mixed with pressing agent such that the desired S-value is obtained and the mixture is milled and spray dried to obtain a powder material with the desired properties. Next, the powder material is compacted and sintered. Sintering is performed at a temperature of 1300-1500° C., in a controlled atmosphere of about 50 mbar followed by cooling. As a result inserts with an essentially cubic carbide phase free and binder phase enriched surface zone are obtained. After conventional post sintering treatments including edge rounding and possibly grinding on at least one side—whereby the surface zone is removed—a hard, wear resistant coating according to the below is applied by CVD- or MT-CVD-technique.

The cemented carbide surface is coated with a Ti(C,N) layer and possibly intermediate layers by CVD and/or MTCVD. Subsequently, a CVD process incorporating several different deposition steps, is used to nucleate α-Al₂O₃ at a temperature of 1000° C. In these steps the composition of a CO₂+CO+H₂+N₂ gas mixture is controlled to result in an O-potential required to achieve (006) texture. The α-Al₂O₃-layer is then deposited by conventional CVD at 1000° C. The exact conditions depend on the design of the coating equipment being used. It is within the purview of the skilled artisan to determine the gas mixture in accordance with the present description.

The α-Al₂O₃ is post treated with a surface polishing method, preferably wet-blasting, in order to decrease the surface roughness.

The present invention also relates to the use of inserts according to above for medium and rough machining of steels, at cutting speeds of 110-400 m/min, cutting depths of 0.5-5.0 mm and feeds of 0.1-0.65 mm/rev.

### Example 1

A cemented carbide substrate with the composition of 9.5 wt % Co, 3.6 wt % TaC, 2.3 wt % NbC, 2.5 wt % (Ti,W)C 50/50 (H. C. Starck), 1.1 wt % TiN and balance WC, with a binder phase alloyed with W corresponding to an S-value of 0.83 was produced by conventional milling of the raw material powders, pressing of green compacts and subsequent sintering at 1430° C. Investigation of the microstructure after sintering showed that the cemented carbide inserts had a cubic carbide free zone with a thickness of about 22 μm. The coercivity was 10.5 kA/m corresponding to an average grain size of about 2.5 μm. The cobalt concentration in the zone was 1.4 times that in the bulk of the substrate. This substrate is referred to as “substrate 1”.

### Example 2

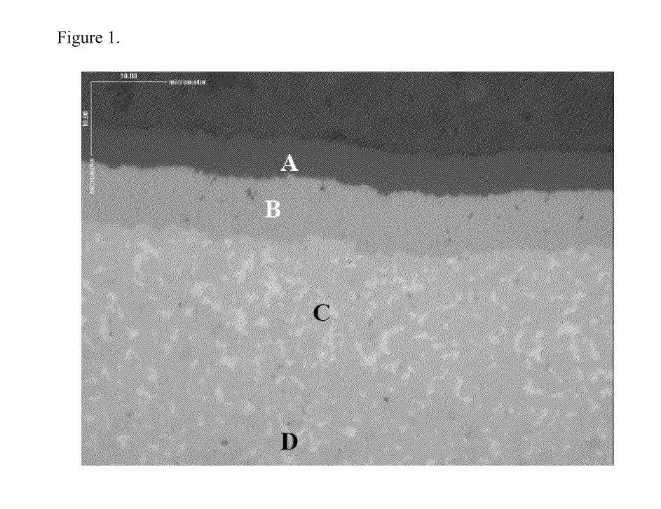

Another cemented carbide substrate was produced as in Example 1, but with 10.0 wt % Co, 4.5 wt % TaC, 2.8 wt % NbC, 2.5 wt % (Ti,W)C. The cubic carbide free zone had a thickness of about 20 μm, see FIG. 1. The coercivity was 10.1 kA/m corresponding to an average grain size of about 2.5 μm. The cobalt concentration in the zone was 1.3 times that in the bulk of the substrate. This substrate is referred to as “substrate 2”.

### Example 3

Cemented carbide cutting inserts from Example 1 and 2 were coated with a layer of MTCVD Ti(C,N). The thickness of the MTCVD layer was about 6 μm. Onto this layer two α-Al₂O₃ layers consisting of about 5 μm α-Al₂O₃ were deposited:

a) A textured α-Al₂O₃ coating was deposited according to Example 2 in the Swedish patent application number 0701703-1, see FIG. 1.

b) A (012)-textured α-Al₂O₃ was deposited according to U.S. Pat. No. 7,135,221.

The layers will be referred to as coatings a) and b). For example, substrate 1 with coating b) is referred to as 1b).

### Example 4

Coatings a) and b) were studied using X-ray diffraction. The texture coefficients were determined and are presented in Table 1. As clear from Table 1 coating a) exhibits a strong (006) texture while coating b) exhibits a strong (012) texture.

TABLE 1

| | | | Coating | Coating |
|---|---|---|---|---|
| h | k | l | a | b |
| 0 | 1 | 2 | 0.26 | 3.52 |
| 1 | 0 | 4 | 0.59 | 0.11 |
| 1 | 1 | 0 | 0.17 | 0.75 |
| 0 | 0 | 6 | 5.63 | 0.00 |
| 1 | 1 | 3 | 0.15 | 0.74 |
| 2 | 0 | 2 | 0.71 | 0.05 |
| 0 | 2 | 4 | 0.18 | 2.56 |
| 1 | 1 | 6 | 0.30 | 0.27 |

### Example 5

Cemented carbide cutting inserts from Example 1 with coatings a) and b) from Example 3 were tested in longitudinal turning of carbon steel.

Work piece: Cylindrical bar

Material: SS1672-08

Insert type: TPUN160308

Cutting speed: 550 m/min

Feed: 0.3 mm/rev

Depth of cut: 3.0 mm

Time in cut: 30 seconds

Remarks: dry turning

The cutting forces of the inserts were measured during the machining and the inserts with coating a) showed approximately 30% smaller cutting force than the inserts with coating b). As a larger deformation region gives rise to increased cutting forces, this example shows that coating a) provides a significantly better resistance to plastic deformation than the coating of prior art.

### Example 6

Cemented carbide cutting inserts from Example 1 with coatings a) and b) from Example 3 were tested in longitudinal turning of carbon steel.

Work piece: Cylindrical bar

Material: SS1672-08

Insert type: CNMG120408-M3

Cutting speed: 300 m/min

Feed: 0.3 mm/rev

Depth of cut: 2.5 mm

Remarks: Turning with coolant

The inserts were inspected after 5 and 10 minutes of cutting. As clear from Table 2 the initial flank wear was similar between the coatings after 5 minutes but after 10 minutes the flank wear was considerably better with the coating produced according to this invention. In addition, the crater wear of coating b) was of much greater magnitude after 10 minutes than that of coating a). It is clear from this example that the combination of Substrate 1 and Coating a) provides superior wear resistance in comparison with the combination 1b).

TABLE 2

| | Flank wear (mm) | Flank wear (mm) |
|---|---|---|
| Substrate/Coating | after 5 minutes | after 10 minutes |
| 1a) (Invention) | 0.12 | 0.14 |
| 1b) | 0.10 | 0.21 |

### Example 7

The following three variants were tested by longitudinal turning of carbon steel:

a. Cemented carbide according to Example 1 with coating a) from Example 3.

b. Strongly leading grade from Competitor 1 for turning of carbon steel.

c. Strongly leading grade from Competitor 2 for turning of carbon steel.

Work piece: Bar with four longitudinal slots

Material: SS1672-08

Insert type: CNMG120408-M3

Cutting speed: 150 m/min

Feed: 0.3 mm/rev

Depth of cut: 2.5 mm

Remarks: Dry turning

Tool life criterion: Flank wear>0.3 mm, two edges of each variant were tested.

| Results: | Tool life (min) |
|---|---|
| 1a) | 18.0 (invention) |
| Competitor 1 | 16.0 (prior art) |
| Competitor 2 | 15.0 (prior art) |

This shows that the cemented carbide tool consisting of the combination of Substrate 1 and Coating a) according to the invention exhibits enhanced tool life as compared with competitor products.

### Example 8

The following three variants were tested by longitudinal turning in an interrupted machining mode introducing high thermal cycling of the cutting edge:

a. Cemented carbide according to Example 2 with coating a) from Example 3.

b. Leading grade from Competitor 1 for turning of carbon steel

c. Leading grade from Competitor 2 for turning of carbon steel

Work piece: Cylindrical bar

Material: SS1672-08

Insert type: CNMG120408-M3

Cutting speed: 200 m/min

Feed: 0.4 mm/rev

Depth of cut: 2.0 mm

Time in cut: 21.1 min

Remarks: With coolant

The inserts were inspected after 5, 10, 15 and 20 minutes of cutting. Both competitors showed increasing signs of flank wear, crater wear and plastic deformation while the inserts produced according to the invention showed only minor signs of wear after 21.1 minutes.

1. Cutting tool insert particularly useful for toughness demanding machining such as medium and rough turning of steels and also for turning of stainless steels consisting of a cemented carbide substrate and a coating characterised in that:
the cemented carbide substrate comprises
WC, 8-11 wt % Co and 6.5-11.0 wt % carbides of the metals Ta, Nb and Ti.
a coercivity of 8-14 kA/m.
a Co-binder highly alloyed with W with an S-value of 0.79-0.90.
the cemented carbide substrate has a binder phase enriched and essentially cubic carbide free surface zone of a thickness of 10-40 μm.
said coating comprises
at least one 2-9 μm α-Al₂O₃ alumina layer composed of columnar grains with texture coefficients
a) TC(006)>2, preferably >3 and <6, and preferably <5.
b) TC(012), TC(110), TC(113), TC(202), TC(024) and TC(116) are all <1
c) TC(104) is the second highest texture coefficient, the texture coefficients (TC) for the α-Al₂O₃ layer being determined as follows:
$$TC ( hkl ) = {\frac{I ( hkl )}{{I}_{0} ( hkl )} [ \frac{1}{n} {\sum }_{n = 1}^{n} \frac{I ( hkl )}{{I}_{0} ( hkl )} ]}^{- 1}$$
where
I(hkl)=intensity of the (hkl) reflection.
Io(hkl)=standard intensity according to JCPDS card no 46-1212.
n=number of reflections used in the calculation.(hkl) reflections used are: (012), (104), (110), (006), (113), (202),
(024) and (116).

2. Cutting insert according to claim 1 characterised in said columnar α-Al₂O₃ grains with a length/width ratio from 2 to 12, preferably 4 to 8.

3. Cutting tool insert according to claim 2 characterized in that the coating further comprising a first layer adjacent the cemented carbide substrate being comprised of CVD Ti(C,N), CVD TiN, CVD TiC, MTCVD Ti(C,N), MTCVD Ti(C,O,N), or combinations thereof, preferably of Ti(C,N) having a thickness of from 2 to 10 μm, preferably from 5 to 7 μm.

4. Cutting insert according to claim 1 characterised in a total coating thickness of 7-15 μm, preferably 9-13 μm.

5. Cutting tool insert according to claim 1 characterized in that the α-Al₂O₃ layer is the uppermost layer and with an Rₐ value <1.0 μm, preferably <0.7 μm.

6. Cutting tool insert according to claim 1 characterized in a composition of 9.0-10.0 wt-% Co, 6.5-10 wt-% cubic carbides of Ti, Nb and Ti and balance WC and with a coercivity of 9-14 kA/m.

7. Cutting tool insert according to claim 6 characterized in a composition of 3.0-4.0 wt-% TaC, 1.7-2.7 wt-% NbC and 2.0-3.0 wt-% TiC, and a coercivity of 10.5-12.5 kA/m.

8. Cutting tool insert according to claim 1 characterized in a composition of the cemented carbide substrate of 9.5-10.5 wt-% Co, 8.0-11.5 wt % carbides of Ti, Nb and Ti and balance WC and a coercivity of 8-13 kA/m.

9. Cutting tool insert according to claim 1 characterized in a composition of the cemented carbide substrate of 4.0-5.0 wt-% TaC, 2.4-3.4 wt-% NbC and 2.0-3.0 wt-% TiC and a coercivity of 9.5-11.5 kA/m.

10. Method of operating medium and rough machining of steels, at cutting speeds of 110-400 m/min, cutting depths of 0.5-5.0 mm and feeds of 0.1-0.65 mm/rev, which comprises using the insert of claim 1.
